(19) United States
(12) Patent Application Publication
(10) Pub. No.: US 2017/0120216 A1
(43) Pub. Date: May 4, 2017

(54) DETONATION CYCLE APPARATUS AND METHOD OF OPERATING THE SAME

(71) Applicant: Cameron International Corporation, Houston, TX (US)

(72) Inventor: Chris Kocurek, Houston, TX (US)

(21) Appl. No.: 14/925,583

(22) Filed: Oct. 28, 2015

(51) Int. Cl. B01J 19/24; B01J 19/00

(52) U.S. Cl. CPC B01J 19/24; B01J 19/0006; B01J 2219/24; B01J 2219/00162; B01J 2219/1943

(57) ABSTRACT

A process for the chemical conversion of a reactive feedstock mixture is provided, the process comprising providing an annular reaction chamber having an inlet end and an outlet end; charging to the annular reaction chamber a reactive feedstock to be converted; detonating the reactive feedstock mixture; allowing a detonation wave to propagate around the annular reaction chamber; introducing into the inlet end of the annular reaction chamber the reactive feedstock to maintain propagation of the detonation wave around the annular reaction chamber; allowing components within the reaction chamber to move from the inlet end towards the outlet end; and recovering from the outlet end of the annular reaction chamber the products of chemical conversion of the feedstock by the action of the detonation wave. An apparatus for the conversion of a reactive feedstock is also provided.

### BACKGROUND

The present disclosure relates generally to a detonation cycle apparatus. The apparatus finds use in effecting chemical conversions of components. The present disclosure also relates to a method for chemically converting feed components using a detonation cycle.

The use of pulse detonation to effect a chemical reaction is known. Known pulse detonation systems employ a tube, along which a detonation pulse or shock wave is caused to pass. Components to be converted are charged to the tube, typically as gases or vapors, and one or more chemical reactions occurs as the detonation pulse travels along the tube through the components therein. Such an apparatus is operated in a cycle comprising charging components to the tube, ignition and detonation, and evacuating the converted components from the tube. An operating cycle of this kind has a relatively poor efficiency, with the desired components only being produced during the part of the cycle in which the detonation pulse is travelling through the feed components. In addition, the reliability of components, such as inlet valves, in an apparatus operating the aforementioned cycle can be low.

U.S. Pat. No. 2,958,716 describes a process in which a shock wave is employed to prepare acetylene from hydrocarbons. The process employs a shock wave generated in one of two alternative ways. In a first embodiment, a charge of a combustible mixture is ignited to cause a detonation. The detonation is allowed to pass through a so-called cracking charge consisting of a hydrocarbon to be cracked. The cracking charge comprises a hydrocarbon, such as methane or other lower alkane. Oxygen may be present in the cracking charge, optionally in an amount sufficient to render the cracking charge detonable. U.S. Pat. No. 2,958,716 states that this can lead to increased propagation of the shock wave through the cracking charge. The detonation, if employed, is generated by igniting a combustible mixture of hydrogen and oxygen. The apparatus of U.S. Pat. No. 2,958,716 employs a membrane, such as paper, to separate the detonation charge and the cracking charge from one another prior to the detonation taking place. Some separation of the two charges is also suggested in U.S. Pat. No. 2,958,716 using a layer of inert gas, such as argon. However, the control of the gaseous charges in such an arrangement is particularly difficult. There are no examples of the use of an inert gas separation layer in the specification of U.S. Pat. No. 2,958,716. A further arrangement employs a detonation zone and a cracking zone without any means of separating the detonation and cracking charges. In a second embodiment of U.S. Pat. No. 2,958,716, a shock wave is generated by the use of a shock tube, in which gas pressure is applied to one side of a rupture disc or membrane. The applied pressure differential across the membrane is sufficient to rupture the membrane, thereby generating a shock wave. The shock wave thus generated is caused to pass through the charge to be cracked. In the examples of this second embodiment, the cracking charge is made up of a lower hydrocarbon, typically methane, admixed with an inert gas, in particular argon and helium, and in some examples oxygen. Hydrogen is used in each example as the pressurized driver gas to create the shock wave. The reliance on the use of a plurality of different gas mixtures and the seeming need to employ inert gases renders the process of U.S. Pat. No. 2,958,716 unattractive for use on a commercial scale. The specific examples of U.S. Pat. No. 2,958,716 show a range of efficiencies in converting hydrocarbons in the cracking charge using the two embodiments. When the first embodiment is employed, the conversions of the hydrocarbon range from just a few percent to about 19 percent. The second embodiment, using hydrogen as the shock medium, achieved a hydrocarbon conversion to acetylene of almost 25 percent. Using helium as the shock medium and a mixture of methane and chlorine achieved an overall conversion of methane of about 80 percent. The results in U.S. Pat. No. 2,958,716 clearly suggest that the best conversion is achieved using a shock tube arrangement in which a pressurized inert driver gas is used to generate a shock wave to impact the cracking charge.

U.S. Pat. No. 3,192,280 discloses a process in which methane is converted into acetylene. In the process, a combustible mixture of methane and oxygen is fed to the combustion head of a truncated cone reactor. Methane is fed to the reactant head of the reactor. The combustible mixture is ignited, generating a shock wave that resonates within the reactor and converts the methane at the reactant head. A yield of 65% by weight acetylene on the basis of the methane feed is indicated. U.S. Pat. No. 3,192,280 suggests that other hydrocarbons, from C₁ to C₁₂ may be used as the feedstock to the reactant head of the reactor. The reactor configuration of U.S. Pat. No. 3,192,280 is complex, requiring a sophisticated arrangement of feed lines and nozzles in both the combustion head and the reactant head of the reactor.

U.S. Pat. No. 5,473,885 discloses a pulse detonation engine. The pulse detonation engine has a detonation chamber with a sidewall. At least two fuel ports are located in the sidewall of the detonation chamber and are spaced longitudinally apart from each other. In operation, an oxygen fuel mixture is introduced into the forward port and detonated. This creates a detonation wave which propagates with an air fuel mixture introduced into the rearward fuel port. After the detonation, purge air passes through the chamber before the next detonation. A rotating sleeve valve mounted around the detonation opens and closes the fuel ports as well the purge ports.

More recently, U.S. Pat. No. 7,033,569 discloses a process and apparatus for the conversion of a reactive feedstock, for example a lower alkane, such as methane. The apparatus comprises a reaction zone having an inlet and an outlet, an initiator for initiating a reaction in a reactive mixture of the feedstock in the reaction zone, and a vessel for containing a liquid. In operation, components leaving the reaction zone are caused to pass into a dip pipe extending into the vessel, the vessel having an outlet and the dip pipe extending into the vessel to below the outlet. The reaction zone is provided in a tubular reactor, which is operated on a cycle of charging the feedstock to the tube and igniting the reaction mixture to generate a detonation pulse to travel along the tube.

In the past, work has been conducted into alternative engine designs. One such alternative design is based on the principle of using detonation waves. One form of engine design that employs detonation waves is the pulse detonation wave engine. Concepts and proposals for pulse detonation wave engines are reviewed by K. Kailasanath, ‘Review of Propulsion Applications of Detonation Waves’, AIAA Journal, Vol. 38, No. 9, September 2000, pages 1698 to 1708.

More recently, it has been proposed to employ a rotating detonation wave to generate thrust and form the basis of an engine for propulsion. Such an engine is referred to as a ‘rotating detonation wave engine’.

An example of a rotating detonation wave engine is proposed by D. Schwer, and K. Kailasanath, ‘Rotating Detonation-Wave Engines’, Defense Tech Briefs, February 2013, pages 46 to 47, and ‘Rotating Detonation-Wave Engines’, 2011 NRL Review, pages 90 to 94. The rotating detonation wave engine proposed comprises a generally cylindrical housing having an annular chamber formed therein. In operation, injection and mixing of feed components occurs at a first end of the cylinder. A detonation wave is generated within the annular chamber and propagates continuously around the annular chamber. The second end of the cylinder is provided with an outlet nozzle, through which the products of the detonation wave are exhausted, to generate thrust. This engine concept is further examined by F. Falempin, ‘Continuous Detonation Wave Engine’, Advances on Propulsion Technology for High-Speed Aircraft, 2008, pages 8-1 to 8-16.

A rotating detonation wave engine is also described by P. Wolanski, et al., ‘An Experimental Study of Rotating Detonation Engine’, 20th International Colloquium on the Dynamics of Explosions and Reactive Systems, 2005.

### SUMMARY

It has now been found that the chemical conversion of a gaseous feedstock can be carried out by allowing a rotating detonation wave to propagate through a body of the feedstock and recovering the products of the detonation wave. In particular, in marked contrast to the processes and apparatus described above employing a detonation or shock wave to effect a chemical conversion, the rotating detonation wave allows the chemical conversion to be carried out continuously, allowing for a high throughput of the feedstock.

Accordingly, in a first aspect, the disclosed embodiments provide a process for the chemical conversion of a reactive feedstock mixture, the process comprising:

providing an annular reaction chamber having an inlet end and an outlet end;

charging to the annular reaction chamber a reactive feedstock to be converted;

detonating the reactive feedstock mixture;

allowing a detonation wave to propagate around the annular reaction chamber;

introducing into the inlet end of the annular reaction chamber the reactive feedstock to maintain propagation of the detonation wave around the annular reaction chamber;

allowing components within the reaction chamber to move from the inlet end towards the outlet end; and

recovering from the outlet end of the annular reaction chamber the products of chemical conversion of the feedstock by the action of the detonation wave.

In a further aspect, the disclosed embodiments provide an apparatus for the chemical conversion of a reactive feedstock mixture, the apparatus comprising:

a reactor housing assembly having an inlet end and an outlet end, the housing assembly comprising a radially outer reactor wall and a radially inner reactor wall, the outer reactor wall and inner reactor wall defining therebetween an annular reaction chamber;

an inlet assembly disposed at the inlet end of the reactor housing assembly for introducing a feedstock to be converted into the annular reaction chamber;

an ignition assembly for detonating a charge of the feedstock within the annular reaction chamber to generate a detonation wave that propagates around the annular reaction chamber; and

a product recovery assembly for recovering the products of detonation of the feedstock within the annular reaction and removing the products from the reactor housing.

The method of the disclosed embodiments may be used to convert a wide range of feed components, in particular in a continuous manner. For conversion in the method and apparatus of the disclosed embodiments, the feed components are in a gaseous state; that is, the feed components are normally gaseous under standard conditions of temperature and pressure or are a gas under the conditions prevailing in the reaction chamber.

In the method of the disclosed embodiments, the annular reaction chamber is initially charged with a reactive mixture. The reactive mixture may comprise any mixture of components to be converted that are capable of reacting in a detonation regime, thereby producing in the annular reaction chamber a detonation wave. Suitable components for the reactive feedstock and their relative proportions in the feedstock mixture may be readily determined.

The reactive feedstock may consist of a single component, provided the single component is able to rapidly decompose in a detonation regime under conditions prevailing in the annular reaction chamber. In many embodiments, the reactive feedstock comprises a plurality of components that react under conditions prevailing in the reaction chamber in a detonation regime. The method and apparatus of the disclosed embodiments may be used to convert a wide range of reactive components, in particular reactive components that are gaseous under the conditions prevailing in the reaction chamber.

In particular, the method of the disclosed embodiments is useful in the conversion of hydrocarbons. In certain embodiments, the hydrocarbon feedstock comprising one or more hydrocarbons is mixed with an oxygen-containing gas, such as air, oxygen-enriched air or oxygen, to form a combustible mixture. The hydrocarbon components and the oxygen-containing gas are mixed in relative amounts to form a mixture capable of detonation, once ignited.

Suitable hydrocarbons for conversion in the apparatus and method of the disclosed embodiments are those that are gaseous at conditions prevailing in the reaction chamber. Suitable hydrocarbons include normally gaseous compounds, that is hydrocarbons that are gases at standard temperature and pressure, in particular C₁ to C₄ hydrocarbons. Higher hydrocarbons may be processed, provided they are present as a gas either at the time of injection into the reaction chamber or are quickly gasified under the conditions in the reaction chamber. Examples of higher hydrocarbons include C₅ to C₁₀ hydrocarbons. The hydrocarbons may be saturated or unsaturated or a mixture thereof. The hydrocarbons may be aliphatic, alicyclic or aromatic, or a mixture of such compounds.

In operation of the method, the reactive feedstock is introduced into the reaction chamber at the inlet end of the reaction chamber. The components of the reactive feedstock may be introduced individually and mixed in the reaction chamber. Alternatively, the components of the feedstock may be mixed prior to being introduced into the reaction chamber.

The reactive feedstock is ignited or detonated in the reaction chamber; that is, a reaction in the feedstock is initiated, to form a detonation wave. The method of detonating the reactive feedstock will depend upon the composition of the feedstock. For example, in the case of a mixture of combustible components and an oxygen-containing gas, the ignition source may be a spark.

In operation, the detonation wave propagates through the annular reaction chamber in a circular path. Reactive feedstock to be converted is fed continuously into the reaction chamber during operation. In this way, propagation of the detonation wave through the reaction chamber is maintained. This in turn allows for a continuous operation of the method, providing for a continuous conversion of reactive feedstock within the reaction chamber. The products of the conversion are removed, such as continuously, from the outlet end of the annular reaction chamber and recovered therefrom.

The reactive feedstock is fed into the reaction chamber at a sufficient flowrate to maintain the detonation wave. The reactive feedstock is introduced into the reaction chamber at its inlet end in a pattern sufficient to ensure that the detonation wave propagates and can travel continuously through the reaction chamber. In particular, it is required that sufficient reactive feedstock is introduced into the reaction chamber ahead of the advancing detonation wave, to allow the detonation wave to properly propagate.

The reactive feedstock may be introduced into the inlet end of the reaction chamber continuously. In certain embodiments, the reactive feedstock is introduced into the reaction chamber in a discontinuous manner, such as still with the supply of reactive feedstock being timed with the passage of the detonation wave through the reaction chamber. Appropriate timing of the introduction of the reactive feedstock into the reaction chamber ensures the continuous propagation of the detonation wave through the reaction chamber.

In one embodiment, the reactive feedstock is introduced into the inlet end of the reaction chamber through a plurality of inlets. In certain embodiments, the reactive feedstock is introduced sequentially through the plurality of inlets, with timing of the feedstock introduction being coordinated with the movement of the detonation wave, e.g., such that feedstock is introduced through an inlet in advance of the detonation wave.

The conversion of the components of the feedstock is effected as the detonation wave passes through the reaction chamber. In particular, the detonation wave propagates circumferentially around the reaction chamber in the region adjacent the inlet end of the reaction chamber, the reactive feedstock being converted as the detonation wave propagates therethrough. As a result of the detonation, the gaseous conversion products, together with any unreacted feedstock are accelerated in the reaction chamber in the axial direction towards the outlet end. The speed of the accelerated gases will depend upon such factors as the shape of the walls defining the reaction chamber.

In certain embodiments, the gaseous components are accelerated under the action of the detonation wave to supersonic speeds in a first region of the reaction chamber adjacent the inlet end. The acceleration to supersonic speeds may be achieved by appropriate shaping of the reaction chamber, as will be described in more detail below. Acceleration of the gaseous components in this way increases both the speed of the components in the axial direction towards the outlet end and the back pressure exerted on the inlet end of the reaction chamber.

In the method of the disclosed embodiments, the gaseous components may be decelerated in a second region of the reaction chamber adjacent the outlet end. As a result of the deceleration both the speed and the pressure of the gaseous components is reduced. In this way, the gaseous components may be more easily recovered from the outlet end of the reaction chamber. In particular, the gaseous components may be decelerated to a subsonic speed before reaching the outlet end of the reaction chamber. The deceleration of the gaseous components may be achieved by appropriate shaping of the reaction chamber, as described in more detail below.

In certain embodiments of the disclosed method, after detonation, the gaseous components expand axially in the direction from the inlet end to the outlet end of the reaction chamber, with the gaseous components being accelerated to a supersonic speed in a first region of the reaction chamber and, thereafter, being decelerated to a subsonic speed in a second region of the reaction chamber, before being recovered from the reaction chamber at the outlet end.

As noted above, the disclosed embodiments also provide an apparatus for the conversion of a reactive feedstock using a detonation wave.

The apparatus of the disclosed embodiments comprises a reactor housing assembly. The reactor housing assembly has an inlet end, at which a feedstock to be converted is introduced, and an outlet end, at which the products of the conversion are recovered, as described hereinafter.

The reactor housing assembly comprises a radially inner reactor wall and a radially outer reactor wall. The inner and outer reactor walls define an annular cavity therebetween, forming an annular reactor chamber. In particular, the annular cavity is defined by the radially outer face of the inner reactor wall and the radially inner face of the outer reactor wall. The reactor housing assembly has a longitudinal axis extending from the inlet end to the outlet end.

The outer face of the inner reactor wall may be generally cylindrical. Similarly, the inner face of the outer reactor wall may be generally cylindrical. When both the aforementioned faces are generally cylindrical, the annular cavity defined therebetween is uniform in radial cross-sectional area extending in the direction from the inlet end to the outlet end of the reactor housing assembly.

In certain embodiments, the annular cavity defined by the inner and outer reactor walls is non-uniform. In particular, the radial cross-sectional area of the annular reactor chamber may vary in the direction extending from the inlet end to the outlet end of the reactor housing assembly.

In one embodiment, the annular reactor chamber has a first region extending from the inlet end of the reactor housing assembly. The radial cross-section of the first region of the annular reactor chamber decreases, that is the first region narrows, in the direction extending from the inlet end to the outlet end of the reactor housing assembly. In this respect, the first region may be considered have a first end proximal the inlet end of the housing and a second end distal the inlet end of the housing, with the cross-sectional area of the first end being greater than that of the second end. In this way, gaseous feedstock and conversion products in the reactor chamber are caused to accelerate as they move axially from the inlet towards the outlet. In particular, the first region may be shaped to accelerate the gases moving in the axial direction towards the outlet end to supersonic speeds.

The change in cross-sectional area of the first region may be discontinuous, for example occurring in one or more steps. For example, the change in cross-sectional area may be continuous, such that the cross-sectional area of the first region decreases continuously extending from the inlet end of the housing in the direction of the outlet end of the housing.

The change in cross-sectional area of the first region may be provided by a portion of the outer surface of the inner reactor wall and/or a portion of the inner surface of the outer reactor wall extending at an angle to the longitudinal axis of the reactor housing assembly. In one embodiment, the portion of the outer surface of the inner reactor wall adjacent the inlet end extends at an angle to the longitudinal axis.

In another embodiment, the annular reactor chamber has a second region extending from the outlet end of the reactor housing assembly. The radial cross-section of the second region of the annular reactor chamber increases, that is the second region widens, in the direction extending from the inlet end to the outlet end of the reactor housing assembly. In this respect, the second region may be considered have a first end distal the outlet end and a second end proximal the outlet end, with the cross-sectional area of the first end being less than that of the second end. In this way, gaseous feedstock and conversion products moving in the reactor chamber in the direction from the inlet end to the outlet are caused to decelerate as they move from towards the outlet. In addition, the speed of the detonation wave passing through the reactor chamber in the second region is caused to decrease towards the second end of the second region.

The change in cross-sectional area of the second region may be discontinuous, for example occurring in one or more steps. For example, the change in cross-sectional area may be continuous, such that the cross-sectional area of the first region increases continuously extending from the inlet end of the housing in the direction of the outlet end of the housing.

The change in cross-sectional area of the second region may be provided by a portion of the outer surface of the inner reactor wall and/or a portion of the inner surface of the outer reactor wall extending at an angle to the longitudinal axis of the reactor housing assembly. In one embodiment, the portion of the outer surface of the inner reactor wall adjacent the inlet end extends at an angle to the longitudinal axis.

In certain embodiments, the annular reactor chamber has both a first region and a second region, as described hereinbefore.

The apparatus further comprises an inlet assembly for introducing a reactive feedstock into the reaction chamber. The inlet assembly comprises one or more inlet openings in the inlet end of the reaction chamber and is operable to introduce reactive feedstock into the reaction chamber, to thereby maintain propagation of the detonation wave.

The inlet assembly may include a valve assembly for controlling the flow of reactive feedstock through the inlet opening, in particular allowing the flow of reactive feedstock into the inlet end of the reaction chamber to be timed with the passage of the detonation wave through the reaction chamber.

In one embodiment, the inlet assembly comprises a plurality of inlets opening into the reaction chamber through which reactive feedstock is passed into the reaction chamber. The plurality of inlets may be spaced equidistantly around the annular reaction chamber. The inlets may be permanently open, with reactive feedstock flowing through each inlet continuously into to the reaction chamber during operation.

In certain embodiments, each inlet is provided with a valve to control the flow of reactive feedstock therethrough. In operation, the opening of the valves to allow the injection of reactive feedstock into the reaction chamber through the respective inlet is timed to be in advance of the detonation wave, such that reactive feedstock is introduced into the inlet end of the reaction chamber ahead of the advancing detonation wave. In particular, one or more inlet valves ahead of the detonation wave are opened to inject reactive feedstock into the reaction chamber, while one or more inlet valves behind the detonation wave are closed. The inlet valves are opened and closed sequentially in this manner. In this way, the propagation of the detonation wave around the reaction chamber is maintained.

A control system is provided to control the opening and closing of the one or more inlet valves. The opening and closing of the inlet valves may be coordinated with the propagation of the detonation wave through the annular reaction chamber. In particular, the apparatus comprises a sensor assembly to monitor the position of the detonation wave within the reaction chamber during operation. For example, the sensor assembly may comprise a plurality of pressure sensors disposed to measure the pressure at a plurality of different locations around the reaction chamber. The control system responds to signals received from the sensor assembly and opens and closes the inlet valves of the plurality of inlets to coordinate the injection of reactive feedstock with the passage of the detonation wave.

For the processing of a reactive feedstock comprising a plurality of components, the inlet assembly may comprise separate inlets for each component, such that each component is injected separately into the reaction chamber and the reactive mixture formed within the reaction chamber. Alternatively, the inlet assembly may operate to mix two or more components to be converted to form the reactive feedstock, prior to injection into the reaction chamber.

The rate of injection of the reactive feedstock into the reaction chamber will depend upon such factors as the shape and configuration of the reaction chamber and the speed of propagation of the detonation wave. As noted above, the reactive feedstock should be injected into the reaction chamber at a position and at a rate sufficient to maintain propagation of the detonation wave.

The apparatus further comprises an ignition assembly for detonating the reactive feedstock within the reaction chamber and generating the detonation wave. The form of the ignition assembly may vary, for example according to the component or components to be converted and the nature of the conversion reactions. In the case of a reactive feedstock comprising an oxygen-containing gas and a combustible component, such as a hydrocarbon, the ignition assembly may comprise a spark generator. In general, once the detonation wave has been initiated, the ignition assembly is not required to continue operating.

The apparatus further comprises a product recovery assembly through which the products of the conversion leave the reaction chamber and are recovered. The product recovery assembly may comprise one or more outlet openings in the reactor vessel assembly, through which the conversion products leave the reaction chamber. The product recovery assembly further comprises a conduit for collecting the conversion products and leading them away from the reactor vessel assembly.

One or more valves may be provided to control the flow of fluid through each outlet opening. The opening of the valves may be timed with respect to the movement of the detonation wave within the reaction chamber, for example by way of a central processor.

### BRIEF DESCRIPTION OF THE DRAWINGS

Embodiments of the method and apparatus of the present disclosure will now be described, by way of example only, having reference to the accompanying drawings, in which:

FIG. 1 is a side view of an apparatus according to certain embodiments;

FIG. 2 is a longitudinal cross-sectional view through the apparatus of FIG. 1 along the line II-II;

FIG. 3 is a detailed view of a portion of the apparatus of FIG. 2 showing a cross-sectional view of a portion of the annular reaction chamber; and

FIG. 4 is a diagrammatic representation of the annular reaction chamber of the apparatus of FIG. 1 in operation.

### DETAILED DESCRIPTION OF SPECIFIC EMBODIMENTS

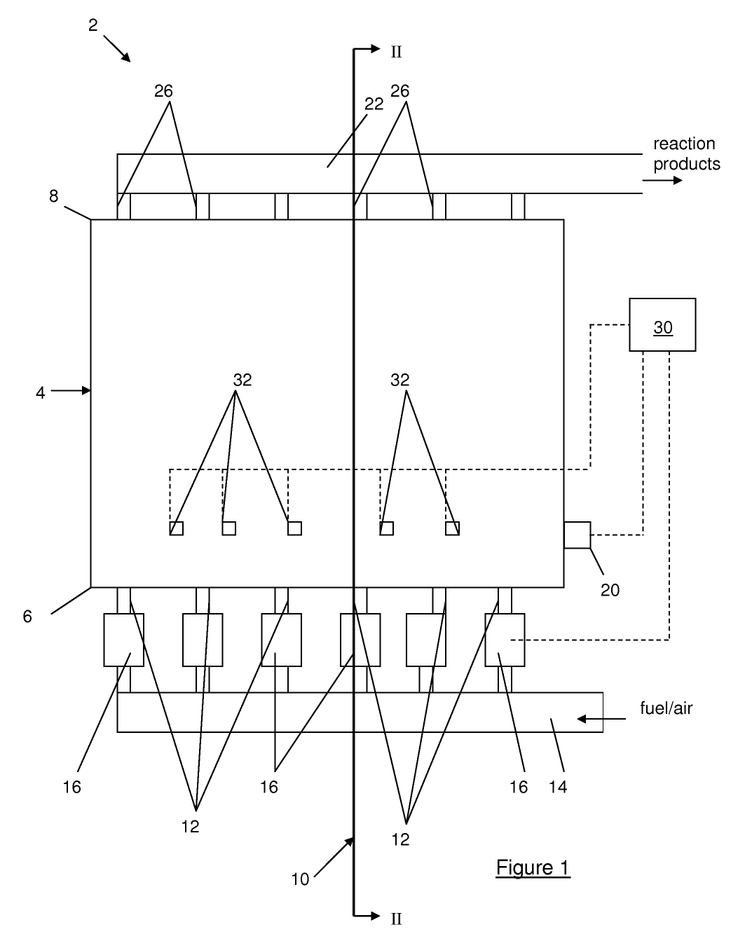

Turning to FIG. 1, there is shown an apparatus for the chemical conversion of a reactive feedstock mixture, generally indicated as 2. The apparatus 2 comprises a generally cylindrical reactor housing assembly 4 defining therein a reaction chamber, as described in more detail below, and having an inlet end 6 and an outlet end 8.

The apparatus 2 comprises an inlet assembly 10 for supplying a reactive feedstock to the inlet end of the reaction chamber within the housing assembly 4. The inlet assembly 10 comprises a plurality of inlet conduits 12, each inlet conduit connecting a respective opening in the inlet end of the reaction chamber with a feed header 14. A valve 16 is provided in each inlet conduit 12 to allow the flow of reactive feedstock to the inlet opening to be controlled.

As shown in FIG. 1, a single inlet assembly 10 is provided, for supplying a single reactive feedstock to the reactor housing assembly 4, for example a single reactive component or a mixture of two or more reactive components, such as a fuel/air mixture. It will be appreciated that in embodiments where the reactive feedstock is a mixture of two or more components, such as a fuel air mixture, a plurality of inlet assemblies may be provided, each as described above and shown in FIG. 1 and delivering one or more components to the inlet end of the housing assembly 4. In this way, the reactive feedstock may be formed at the inlet end of the housing assembly from a supply of separate reaction components.

An ignition assembly 20 is provided. The ignition assembly 20 comprises an igniter, operable to initiate reaction of the reactive components in the reactive feedstock within the reaction chamber of the housing assembly, to thereby form the detonation wave. A suitable igniter is a spark generator.

The apparatus 2 further comprises a product recovery assembly 22 disposed at the outlet end 8 of the reactor housing assembly 4. The product recovery assembly 22 comprises a recovery header 24 connected to one or more openings in the outlet end of the reaction chamber by outlet conduits 26, through which the products of the reaction and detonation wave within the reaction chamber leave.

The apparatus further comprises a controller 30. The controller is operable to control various aspects of the operation of the apparatus. First, the controller 30 operates the ignition assembly 20, to initiate the reaction of the reactive components in the feedstock and the detonation wave.

The controller 30 receives signals from a plurality of pressure sensors 32 disposed in the reactor housing assembly 4. The pressure sensors 32 are operable to sense the pressure and pressure variations of the gases within the reaction chamber. Signals received from the pressure sensors 32 are used by the controller 30 to determine the position and movement of the detonation wave within the reaction chamber.

Finally, in response to the signals received from the pressure sensors 32, the controller operates the valves 16 in each inlet assembly 10, in particular to allow components of the reactive feedstock to enter the reaction chamber at a time appropriate to the position and movement of the detonation wave.

Signal lines connecting the controller 30 to the other components of the apparatus are shown by dotted lines in FIG. 1.

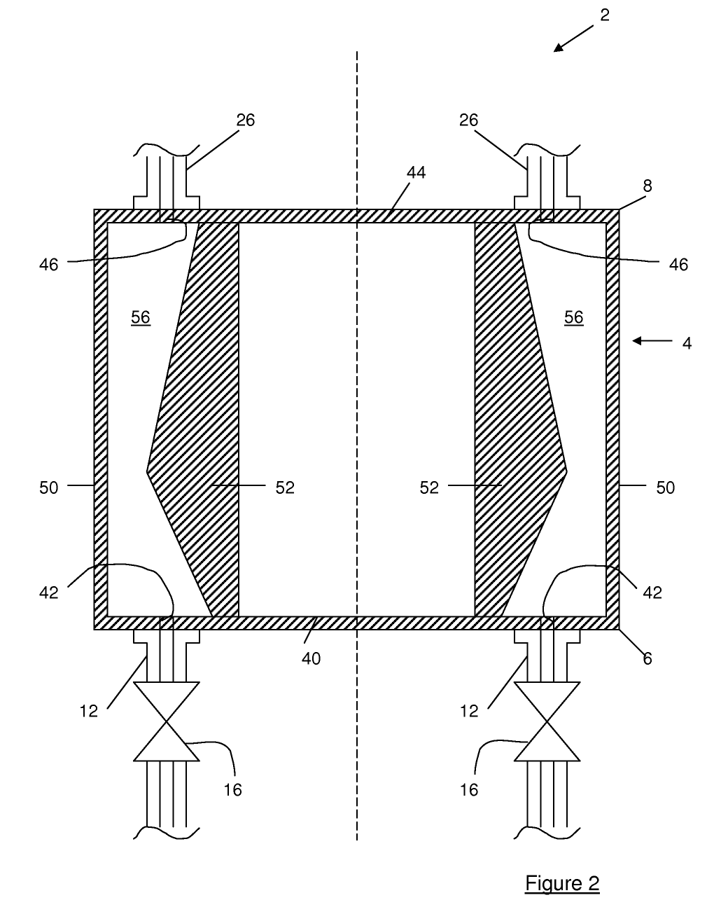

Turning to FIG. 2, there is shown a simplified cross-sectional view of the apparatus of FIG. 1 along the line II-II of FIG. 1. As shown in FIG. 2, the reactor housing assembly 4 comprises an inlet end wall 40 at its inlet end 6, provided with openings 42 therein through which reactive feedstock components enter the housing assembly from the inlet conduits 12. Similarly, the reactor housing assembly 4 comprises an outlet end wall 44 at its outlet end 8, provided with openings 46 therein through which the products of the reaction leave the housing assembly and enter the outlet conduits 26.

The reactor housing assembly 4 further comprises a generally cylindrical outer reactor wall 50 and a generally cylindrical inner reactor wall 52 arranged coaxially with the outer reactor wall 50. The inner and outer reactor walls 52, 50 define therebetween an annular reaction chamber 56.

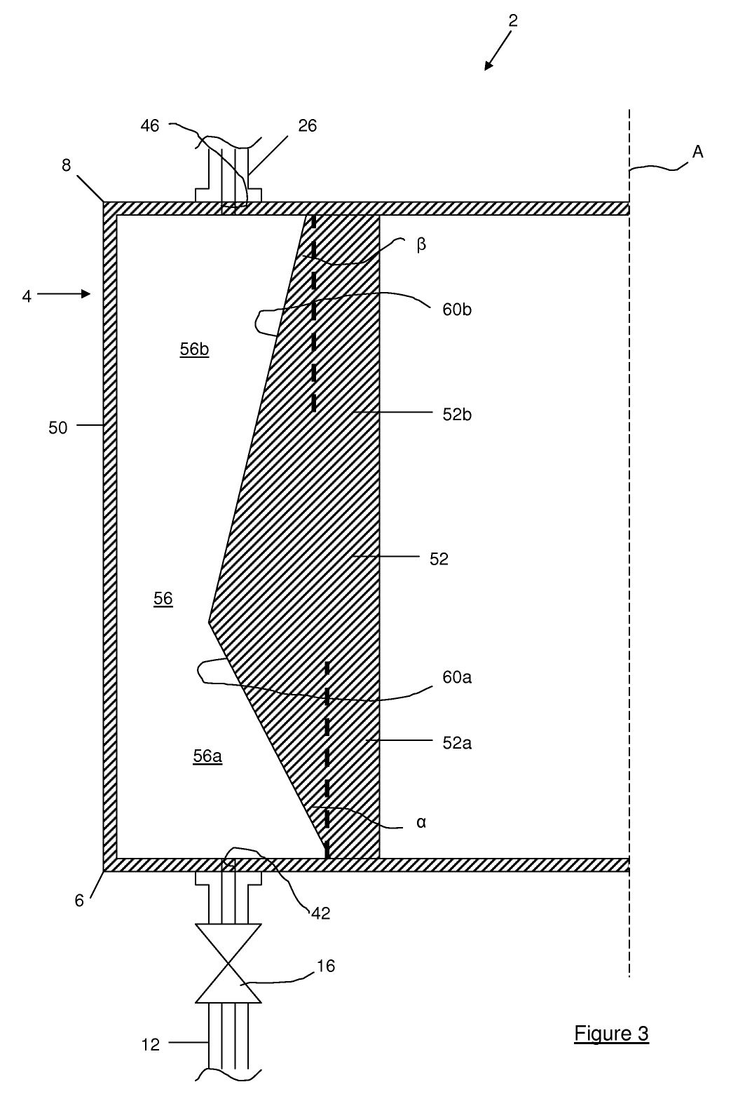

An enlarged cross-sectional view of a portion of the reaction chamber 56 is shown in FIG. 3. As can be seen, the reaction chamber 56 has a first region 56a and a second region 56b, indicated in FIG. 3.

The first region 56a of the reaction chamber 56 extends from the inlet end 6 to a central region of the reactor housing assembly 4 and reduces in cross-sectional area in the direction towards the outlet end 8. The variation in the cross-sectional area of the first region 56a is provided by a first portion 52a of the inner reactor wall 52 being tapered, such that its outer surface 60a extends at an angle a to the longitudinal axis A of the reactor housing assembly 4.

The second region 56b of the reaction chamber 56 extends from the outlet end 6 of the reactor to a central region of the housing assembly 4 and increases in cross-sectional area in the direction towards the outlet end 8. The variation in the cross-sectional area of the second region 56b is provided by a second portion 52b of the inner reactor wall 52 being tapered, such that its outer surface 60b extends at an angle β to the longitudinal axis A of the reactor housing assembly 4.

In operation, a gaseous reactive feedstock comprising one or more reactive components is feed to the inlet end of the first region 56a of the reaction chamber 56 by the inlet assembly 10. The flow of reactive components into the reaction chamber 56 is controlled by the controller 30 and the valves 16. Ignition of reactive components within the reaction chamber 56 generates a detonation wave, which propagates around the annular reaction chamber 56 in a continuous manner. The controller 30 operates the valves 16 to supply reactive feedstock to the reaction chamber 56 at an appropriate time and for an appropriate duration relative to the position and movement of the detonation wave.

In general, components move longitudinally through the reaction chamber from the inlet end 6 to the outlet end 8. The products of the reaction of the feed components and any unreacted components leave the reaction chamber 56 through the outlet opening 46 and are collected in the product recovery assembly for removal and further processing, as appropriate.

During operation, as a result of the form of the first portion 52a of the inner reactor wall 52 defining the first region 56a of the reaction chamber 56 extending from the inlet end 6, the gases within the reaction chamber are accelerated when moving from the inlet end 6 towards the outlet end 8. In particular, the gaseous components can be accelerated to super-sonic speeds within the first region 56a of the reaction chamber 56.

When passing through the second region 56b of the reaction chamber 56, the gaseous components are caused to decelerate, as a result of the form of the second portion 52b of the inner reactor wall 52 defining the second region 56b of the reaction chamber 56 extending to the outlet end 8.

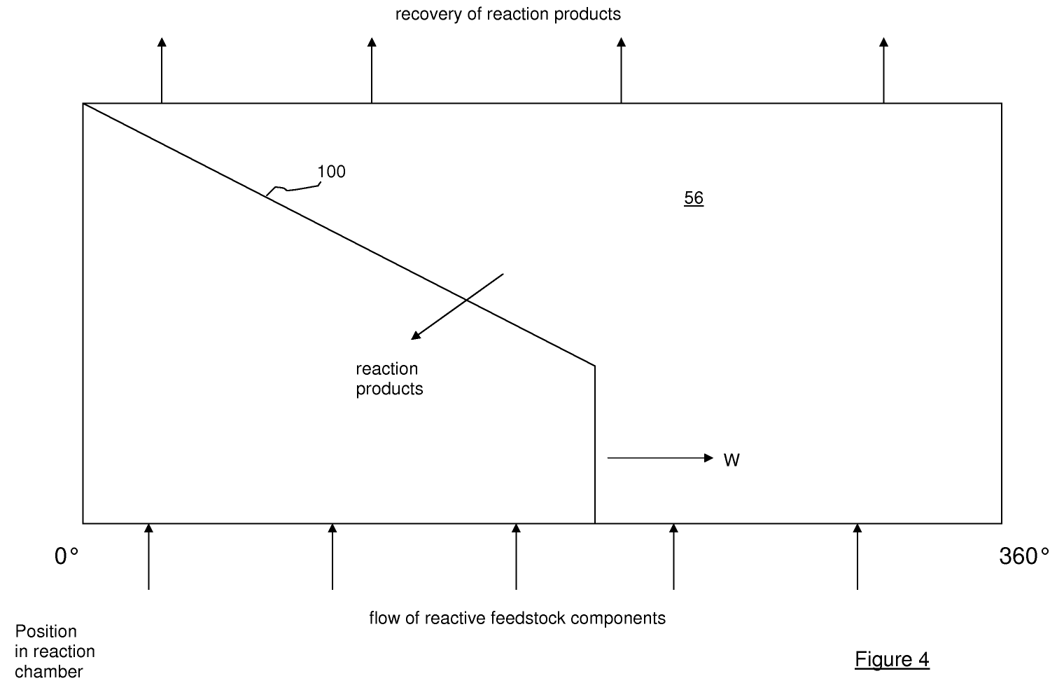

The general propagation of a detonation wave 100 around the entire reaction chamber 56 and the flow of components within the reaction chamber 56 is shown schematically in FIG. 4. The direction of travel of the detonation wave 100 is indicated by the arrow W.

1. A process for the chemical conversion of a reactive feedstock mixture, the process comprising:
providing an annular reaction chamber having an inlet end and an outlet end;
charging to the annular reaction chamber a reactive feedstock to be converted;
detonating the reactive feedstock mixture;
allowing a detonation wave to propagate around the annular reaction chamber;
introducing into the inlet end of the annular reaction chamber the reactive feedstock to maintain propagation of the detonation wave around the annular reaction chamber;
allowing components within the reaction chamber to move from the inlet end towards the outlet end; and
recovering from the outlet end of the annular reaction chamber the products of chemical conversion of the feedstock by the action of the detonation wave.

2. The process according to claim 1, wherein the reactive feedstock comprises components that are normally gaseous.

3. The process according to claim 1, wherein the reactive feedstock comprises a plurality of components.

4. The process according to claim 3, wherein the reactive feedstock comprises a hydrocarbon and an oxygen-containing gas.

5. The process according to claim 4, wherein the hydrocarbon is selected from C₁ to C₄ hydrocarbons and mixtures thereof.

6. The process according to claim 5, wherein the hydrocarbon is methane.

7. The process according to claim 1, wherein the reactive feedstock comprises a plurality of components and the components of the reactive feedstock are mixed before being introduced into the reaction chamber.

8. The process according to claim 1, wherein the reactive feedstock is introduced into the reaction chamber in a continuous manner.

9. The process according to claim 1, wherein the reactive feedstock is introduced into the reaction chamber in a discontinuous manner.

10. The process according to claim 9, wherein the introduction of the reactive feedstock into the reaction chamber is occurs at a time and for a duration that is coordinated with the passage of the detonation wave through the reaction chamber.

11. The process according to claim 1, wherein the reactive feedstock is introduced into the reaction chamber through a plurality of inlets.

12. The process according to claim 1, wherein the reaction chamber comprises a first region adjacent the inlet end of the reaction chamber.

13. The process according to claim 12, wherein the components within the reaction chamber are accelerated in the first region in the direction towards the outlet end.

14. The process according to claim 13, wherein the components are accelerated to a supersonic speed.

15. The process according to claim 12, wherein the reaction chamber comprises a second region adjacent the outlet end of the reaction chamber.

16. The process according to claim 15, wherein the components within the reaction chamber are decelerated in the second region in the direction towards the outlet end.

17. The process according to claim 16, wherein the components are decelerated to a subsonic speed.

18. An apparatus for the chemical conversion of a reactive feedstock mixture, the apparatus comprising:
a reactor housing assembly having an inlet end and an outlet end, the housing assembly comprising a radially outer reactor wall and a radially inner reactor wall, the outer reactor wall and inner reactor wall defining therebetween an annular reaction chamber;
an inlet assembly disposed at the inlet end of the reactor housing assembly for introducing a feedstock to be converted into the annular reaction chamber;
an ignition assembly for detonating a charge of the feedstock within the annular reaction chamber to generate a detonation wave that propagates around the annular reaction chamber; and
a product recovery assembly for recovering the products of detonation of the feedstock within the annular reaction and removing the products from the reactor housing.

19. The apparatus according to claim 18, wherein the radial cross-sectional area of the annular reactor chamber varies in the direction extending from the inlet end to the outlet end of the reactor housing assembly.

20. The apparatus according to claim 19, wherein the annular reactor chamber has a first region extending from the inlet end of the reactor housing assembly, the radial cross-section of the first region of the annular reactor chamber decreasing in the direction extending from the inlet end to the outlet end of the reactor housing assembly.

21. The apparatus according to claim 20, wherein the first region has a first end proximal the inlet end of the housing and a second end distal the inlet end of the housing, with the cross-sectional area of the first end being greater than that of the second end.

22. The apparatus according to claim 21, wherein the cross-sectional area of the first region reduces continuously from the first end to the second thereof.

23. The apparatus according to claim 22, wherein the change in cross-sectional area of the first region is provided by a portion of the outer surface of the inner reactor wall and/or a portion of the inner surface of the outer reactor wall extending at an angle to the longitudinal axis of the reactor housing assembly.

24. The apparatus according to claim 19, wherein the annular reactor chamber has a second region extending from the outlet end of the reactor housing assembly, the radial cross-section of the second region of the annular reactor chamber increasing in the direction extending from the inlet end to the outlet end of the reactor housing assembly.

25. The apparatus according to claim 24, wherein the second region has a first end distal the inlet end of the housing and a second end proximal the inlet end of the housing, with the cross-sectional area of the first end being less than that of the second end.

26. The apparatus according to claim 25, wherein the cross-sectional area of the second region increases continuously from the first end to the second thereof.

27. The apparatus according to claim 26, wherein the change in cross-sectional area of the second region is provided by a portion of the outer surface of the inner reactor wall and/or a portion of the inner surface of the outer reactor wall extending at an angle to the longitudinal axis of the reactor housing assembly.

28. The apparatus according to claim 18, wherein the inlet assembly comprises a plurality of openings into the reaction chamber in the inlet end of the reactor housing assembly.

29. The apparatus according to claim 28, wherein each inlet opening is provided with a valve to control the flow of reactive feedstock into the reaction chamber through the inlet opening.

30. The apparatus according to claim 18, further comprising a controller.

31. The apparatus according to claim 30, wherein the apparatus further comprises one or a plurality of pressure sensors to detect the pressure and/or pressure changes within the reaction chamber, the controller being responsive to signals received from the or each pressure sensor.
